(19) United States
(12) Patent Application Publication
(10) Pub. No.: US 2026/0299239 A1
(43) Pub. Date: Oct. 1, 2026

(54) OPTICAL FIBER CABLE CONFIGURED FOR LOW ATTENUATION CHANGE DURING CRUSH EVENTS

(71) Applicant: CORNING RESEARCH & DEVELOPMENT CORPORATION, Corning, NY (US)

(72) Inventors: Michael Rhea Ellwanger, Hickory, NC (US); Andrii Kovalchuk, Lodz (PL); Marcin Mateusz Krawczyk, Lodz (PL); Anna Lipiec, Lodz (PL); Sebastian Olszewski, Aleksandrów (PL); Tomasz Stolarczyk, Swedów (PL); Yaochi Wei, Pittsford, NY (US); Zhiye Zhang, Hickory, NC (US)

(21) Appl. No.: 19/685,326

(22) Filed: May 22, 2026

Related U.S. Application Data
(63) Continuation of application No. PCT/US2024/056035, filed on Nov. 15, 2024.
(60) Provisional application No. 63/603,799, filed on Nov. 29, 2023.

(51) Int. Cl. G02B 6/44

(52) U.S. Cl. CPC G02B 6/4434; G02B 6/4433

(57) ABSTRACT

Embodiments of the disclosure relate to an optical fiber cable. The optical fiber cable includes an outer jacket defining a first central bore extending along a longitudinal axis of the optical fiber cable. An inner jacket is disposed within the first central bore and defines a second central bore extending along the longitudinal axis. An armor layer is disposed between the outer jacket and the inner jacket. A central strength member is disposed within the second central bore, and the central strength member includes a central member, a first layer, and a second layer. A plurality of buffer tubes is disposed within the second central bore and around the central strength member. The first layer is formed from a first material having a first hardness, and the second layer is formed from a second material having a second hardness that is greater than the first hardness.

### RELATED APPLICATIONS

This application is a continuation of International Patent Application No. PCT/US2024/056035, filed on Nov. 15, 2024, which claims priority to U.S. Provisional Patent Application No. 63/603,799 filed Nov. 29, 2023 and entitled “OPTICAL FIBER CABLE CONFIGURED FOR LOW ATTENUATION CHANGE DURING CRUSH EVENTS,” the entirety of which is incorporated herein by reference.

### BACKGROUND

The disclosure relates generally to optical fiber cables and, in particular, to optical fiber cables with reduced attenuation change when experiencing crush forces. Optical fiber cables are deployed in a variety of different operating environments, including aerial, subterranean, underwater, and over the ground. The optical fiber cable must be configured to withstand the conditions of its respective environment. This can involve exposure to extreme temperature (hot or cold), tensile forces, crush forces, corrosive agents, rodents, fire, and weather, among others. The cable construction can vary to account for the conditions to which the optical fiber cable is exposed with the general goal of maintaining optical transmission despite being subjected to the harshest conditions of that environment, even if such conditions may be rare.

### SUMMARY

According to an aspect, embodiments of the disclosure relate to an optical fiber cable. The optical fiber cable includes an outer jacket having a first inner surface and a first outer surface. The first outer surface defines an outermost surface of the optical fiber cable, and the first inner surface defines a first central bore extending along a longitudinal axis of the optical fiber cable. An inner jacket is disposed within the first central bore, and the inner jacket includes a second inner surface and a second outer surface. The second inner surface defines a second central bore extending along the longitudinal axis. An armor layer is disposed in the first central bore between the first inner surface of the outer jacket and the second outer surface of the inner jacket. A central strength member is disposed within the second central bore, and the central strength member includes a central member, a first layer disposed around the central member, and a second layer disposed around the first layer. A plurality of buffer tubes is disposed within the second central bore and around the central strength member. Each buffer tube of the plurality of buffer tubes contains at least one optical fiber. The first layer is formed from a first material having a first hardness, and the second layer is formed from a second material having a second hardness. The first hardness is less than the second hardness.

According to another aspect, embodiments of the disclosure relate to an optical fiber cable. The optical fiber cable includes an outer jacket having a first inner surface and a first outer surface. The first outer surface defines an outermost surface of the optical fiber cable, and the first inner surface defines a central bore extending along a longitudinal axis of the optical fiber cable. A central strength member is disposed within the central bore, and the central strength member includes a central member and a first layer disposed around the central member. A plurality of optical fibers is disposed within the central bore. The plurality of optical fibers is divided among a plurality of buffer tubes positioned around the central strength member. The first layer is formed from a first material having a Young's modulus of 120 MPa or less. Further, during application of a compressive force of 10 kN to the first outer surface of the outer jacket that is perpendicular to longitudinal axis, 1% or less of the plurality of optical fibers experience a change of attenuation of more than 0.5 dB.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-sectional view of an optical fiber cable, according to an exemplary embodiment;

FIGS. 2A-2E depict cross-sectional views of central strength members, according to exemplary embodiments;

FIG. 3 depicts a cross-sectional view of another optical fiber cable, according to an exemplary embodiment;

FIG. 4 depicts a cross-sectional view of a low bend loss optical fiber, according to an exemplary embodiment;

FIGS. 5 and 6 depict refractive index profiles for cladding trench regions of low bend loss optical fibers, according to an exemplary embodiment;

FIG. 7 is a graph of change in attenuation for optical fibers in a comparative cable and in an optical fiber cable according to the present disclosure during a crush test;

FIG. 8 is a graph of the stress-strain relationship for LLDPE and FRNC in relation to their use as a first layer of the central strength member; and

FIG. 9 is a graph of load-displacement curves for optical fiber cables having different materials for the first layer of the central strength member and different inner jacket thicknesses.

### DETAILED DESCRIPTION

Referring generally to the figures, various embodiments of an optical fiber cable with improved crush performance are provided. As will be discussed more fully below, the optical fiber cable includes a central strength member with a compliant upjacket configured to be deformable when pressed against by buffer tubes in the cable core. In one or more embodiments, the compliant upjacket of the central strength member includes a first layer of a low hardness material surrounded by a skin layer of a relatively higher hardness material. The low hardness material may be a highly-filled bedding compound, and the skin layer may be a polyolefin polymer that maintains the mechanical integrity of the first layer. In one or more other embodiments, the compliant upjacket is a single layer of a compliant material, such as foam or a flame-retardant, non-corrosive polymer. Advantageously, an optical fiber cable with a central strength member having the compliant upjacket construction exhibits improved optical fiber signal attenuation during crush testing. In particular, while a load of 10 kN is applied to the optical fiber cable, the optical fibers experience an attenuation change of 0.5 dB or less. Exemplary embodiments of the optical fiber cable with improved crush performance will be described in greater detail below and in relation to the figures provided herewith, and these exemplary embodiments are provided by way of illustration, and not by way of limitation.

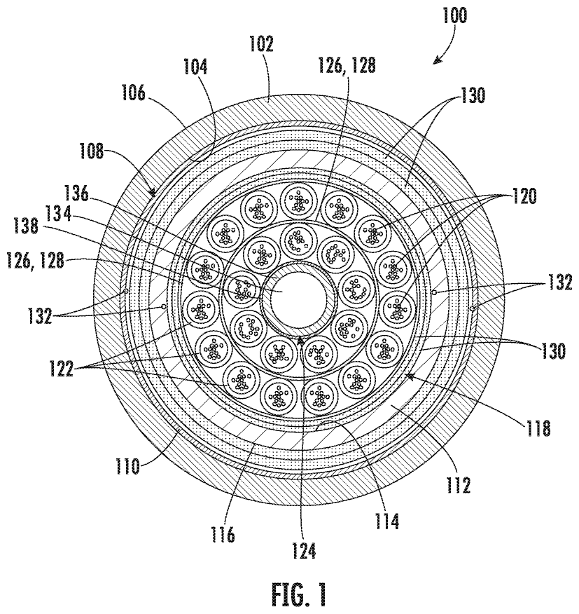

FIG. 1 depicts an example embodiment of an optical fiber cable 100. The optical fiber cable 100 includes an outer jacket 102 having a first inner surface 104 and a first outer surface 106. The first outer surface 106 is the outermost surface of the optical fiber cable 100. The first inner surface 104 defines a first central bore 108. Disposed within the first central bore 108 is an armor layer 110 and an inner jacket 112. The inner jacket 112 is a longitudinally continuous and circumferentially contiguous polymeric tube extending along the length of the optical fiber cable 100 for at least the same length as the armor layer 110. The inner jacket 112 includes a second inner surface 114 and a second outer surface 116. According to embodiments of the present disclosure, the armor layer 110 is disposed between the first inner surface 104 of the outer jacket 102 and the second outer surface 116 of the inner jacket 112.

The second inner surface 114 of the inner jacket 112 defines a second central bore 118. Disposed within the second central bore 118 are one or more optical fibers 120. In one or more embodiments, including the embodiment of FIG. 1, the optical fibers 120 are contained within buffer tubes 122 in a loose tube configuration. In one or more embodiments, the buffer tubes 122 are stranded in one or more layers around a central strength member 124. In the embodiment depicted in FIG. 1, there are two layers of buffer tubes 122 stranded around the central strength member 124 with the first layer including nine buffer tubes 122 and the second layer including fifteen buffer tubes 122. Further, in the embodiment depicted, each buffer tube 122 contains twelve optical fibers 120, and thus, in the embodiment of the optical fiber cable 100 depicted in FIG. 1, there are 288 optical fibers 120.

In one or more other embodiments, the optical fiber cable 100 includes from one to thirty-six buffer tubes 122, in particular from six to thirty-six buffer tubes. In one or more other embodiments, each buffer tube 122 contains from one to thirty-six optical fibers 120. In one or more embodiments, the buffer tubes 122 may have an inner diameter in a range of from 1.5 mm to 2 mm, in particular about 1.7 mm. In one or more embodiments, the buffer tubes 122 have an outer diameter in a range from 2.0 mm to 2.5 mm, in particular about 2.25 mm. In one or more embodiments, the buffer tubes 122 are comprised of at least one polymer selected from, e.g., polyethylene (PE), polypropylene (PP), copolymers of PE and PP, polyamides (PA), polybutylene terephthalate (PBT), and polycarbonate (PC), among others. For example, the buffer tube 122 may include a composite structure of a layer of PBT around a layer of PC. In such embodiments, the buffer tube 122 may have an inner diameter of about 1.70 mm, an outer diameter of about 2.25 mm, and a diameter at the interface between the layer of PC and the layer of PBT of about 1.93 mm.

In one or more embodiments, the optical fiber cable 100 may include a plurality of other components, such as one or more binding layers 126, one or more layers of water blocking tape 128, one or more layers of strengthening yarns 130, and one or more access features 132, disposed within either or both of the first central bore 108 and the second central bore 118. In the embodiment depicted in FIG. 1, the optical fiber cable 100 includes a first layer of buffer tubes 122 stranded around the central strength member 124. A binding layer 126 is disposed around the first layer of buffer tubes 122, and a layer of water blocking tape 128 is wrapped around the binding layer 126. A second layer of buffer tubes 122 is stranded around the first layer of buffer tubes 122. The second layer of buffer tubes 122 is surrounded by a binding layer 126, which is surrounded by another layer of water blocking tape 128. Disposed around the water blocking tape 128 is one or more layers of strengthening yarns 130. For example, in particular embodiments, the one or more layers of strengthening yarns 130 may include three total layers, such as one layer of aramid yarns (e.g., 9480 dtex) and two layers of glass fiber yarns (e.g., 1200 dtex). The inner jacket 112 is disposed around the layer or layers of strengthening yarns 130. Further, the inner jacker 112 includes access features 132 disposed within the inner jacket 112 or between the inner jacket 112 and the strengthening yarns 130.

Disposed between the second outer surface 116 of the inner jacket 112 and the first inner surface 104 of the outer jacket 102 are a further one or more layers of strengthening yarns 130 (e.g., three layers of glass fiber yarns (1200 dtex)) that is surrounded by the armor layer 110. The outer jacket 102 may also include access features 132 disposed between the strengthening yarns 130 and the armor layer 110.

In one or more embodiments, each access feature 132 is a ripcord that can be grasped by a cable installer and pulled to tear through the armor layer 110 and outer jacket 102 or through the inner jacket layer 112. In one or more embodiments, the ripcord may be a filament of aramid fiber. In one or more embodiments, the water blocking tape 128 may be a strip of woven or nonwoven material impregnated with a superabsorbent polymer (SAP) resin or powder. In one or more embodiments, the water blocking tape 128 has a thickness of from 0.05 mm to 0.5 mm, in particular about 0.1 mm.

In one or more embodiments, the strengthening yarns 130 are comprised of at least one of glass, aramid, basalt, liquid crystal polymer (LCP), carbon fibers, or silicon carbide fibers, among other possibilities. In one or more embodiments, each layer of strengthening yarns 130 has a thickness in a range from 0.1 mm to 0.5 mm, in particular about 0.3 mm. In one or more embodiments, the strengthening yarns 130 are stranded around the underlying cable components, and in one or more other embodiments, the strengthening yarns 130 are woven around the underlying cable components. In one or more embodiments, the minimum number of strengthening yarns 130 in each layer is selected to completely cover the underlying layer, and the maximum number of strengthening yarns 130 in each is layer is selected to provide the desired tensile strength of the optical fiber cable 100.

Each armor layer 110 is formed from a strip or tape of flat material that is wrapped (either directly or indirectly) around the inner jacket 112 or the buffer tubes 122 such that longitudinal edges of the armor layer 110 meet, join, or overlap to form a tubular structure. In this way, the armor layer 110 is longitudinally continuous, circumferentially contiguous, and forms a longitudinal seam or overlap region along the length of the optical fiber cable 100. Further, in one or more embodiments, the longitudinal edges of the armor layer 110 may be welded at least partially along their length.

In one or more embodiments, each armor layer 110 may be corrugated. In one or more other embodiments, each armor layer 110 may be flat. In one or more embodiments, each armor layer 110 may be laminated. For example, the flat material of each metal armor layer 110 may be laminated with another material, such as a polymer (e.g., a PE), to enhance adhesion to the outer jacket 102 or the inner jacket 112. In one or more embodiments, each armor layer 110 may be made from a flat material having a thickness in a range from 0.1 to 0.5 mm, in particular about 0.2 mm. The overall thickness of the armor layer 110 may be greater than the thickness of the flat material depending on whether corrugations are formed into the flat material and whether the flat material is a laminated structure.

In one or more embodiments, each of the binding layer 126, the inner jacket 112, and the outer jacket 102 may be an extruded polymeric material. In one or more embodiments, the binding layer 126 is a relatively thin film extruded around the buffer tubes 122 to hold them in place around the central strength member 124 or around the underlying layer of buffer tubes 122. In one or more embodiments, the binding layer 126 has a thickness in a range from 0.01 to 0.1 mm, in particular about 0.05 mm. In one or more embodiments, the binding layer 126 is comprised of a polyethylene material, including LLDPE, among other possibilities. However, in one or more other embodiments, the binding layer 126 may instead be comprised of binder yarns, such as polyester, aramid, or glass binder yarns. In contrast to the strengthening yarns 130, the binder yarns generally do not form a complete layer around the underlying cable component. For example, the binding layer 126 may include one to three binder yarns stranded around the underlying components to hold them in place.

In one or more embodiments, the inner jacket 112 is extruded around the buffer tubes 122 and central strength member 124 to provide an interior protective jacket to protect the optical fibers 120 in the case that the outer jacket 102 is penetrated. In one or more embodiments, the inner jacket 112 has a thickness that is less than the thickness of the outer jacket 102. In one or more embodiments, the inner jacket 112 has a thickness in a range from 0.5 mm to 3 mm. As will be discussed more fully below, a thicker inner jacket 112 (e.g., in a range from 1.5 mm to 3 mm) provides enhanced resistance to crush loading. In one or more embodiments, the inner jacket 112 is comprised of PE (in particular high density PE), PA, or PP, among other possibilities.

In one or more embodiments, the outer jacket 102 is extruded around all of the interior components of the optical fiber cable 100 and is the outermost layer of the optical fiber cable 100. As the outermost layer, the outer jacket 102 provides the first layer of protection against the environment for the optical fiber cable 100. In one or more embodiments, the outer jacket 102 has a thickness that is greater than the thickness of the inner jacket 112. In one or more embodiments, the outer jacket 102 has a thickness in a range from 1 mm to 3 mm, in particular in a range from 1.25 mm to 2.25 mm, and particularly about 1.5 mm. In one or more embodiments, the outer surface 106 of the outer jacket 102 defines a diameter of the optical fiber cable 100, and the diameter is in a range from 15 mm to 30 mm, in particular in a range from 20 mm to 25 mm. In one or more embodiments, the outer jacket 102 is comprised of PE (in particular high density PE), PA, or PP, among other possibilities.

According to the present disclosure, the optical fiber cable 100 is configured to meet or exceed certain performance specifications. In particular, the optical fiber cable 100 is configured to prevent water penetration as tested according to IEC60794-1-22 F5. Further, the optical fiber cable 100 is configured to pass relevant tensile testing, during and after loading and residual loading, according to IEC60794-1-21 E1. Additionally, the optical fiber cable 100 is configured to withstand temperature cycling without experiencing significant attenuation change as measured according to IEC60794-1-22 F1.

Still further, it is desired that the optical fiber cable 100 exhibit low attenuation of optical signal strength when exposed to crushing forces. Crush tests are intended to simulate crushing or clamping forces that may occur during installation, operation, or maintenance of the optical fiber cable 100. According to the present disclosure, the optical fiber cable 100 is configured to exhibit a single mode attenuation change of 0.5 dB or less during loading with a force of 10,000 N (10 kN) over 10 cm for 1 minute. After removal of the force, the optical fiber cable 100 should exhibit a single mode attenuation change of 0.05 dB or less. The manner of loading optical fiber cable 100 and measuring the attenuation change is outlined in IEC607941-21, Method E3.

Applicant has found that certain existing cable designs exhibit unacceptably high attenuation when subjected to crush testing. After testing, inspection of the interior of the cable revealed that the buffer tubes had collapsed as a result of the crush forces, leading to attenuation of the optical fibers within the buffer tubes. In particular, the buffer tubes in the inner and outer layers around the central strength member had deformed from round to oval-shaped by the forces during the crush test. Essentially, the buffer tubes were pinned between the inner jacket and the central strength member, leading to deformation of the buffer tubes. The deformation of the buffer tubes stressed the optical fibers, leading to increased attenuation of the optical signals transmitted by the optical fibers.

The central strength member of the existing cable design included a central member having a polymeric upjacket providing the desired diameter for stranding the first layer of buffer tubes around the central strength member. Based on the crush performance, Applicant determined that the rigidity of the central strength member contributed to the deformation of the buffer tubes during crush testing. In order to improve crush performance, the optical fiber cable 100 includes a central strength member 124 with decreased rigidity. Advantageously, Applicant found that the crush performance could be improved in a manner that did not increase the material cost of the optical fiber cable 100.

According to the present disclosure, the central strength member 124 includes a central member 134, such as a glass-(or other fiber-) reinforced plastic rod or a metal wire, which is upjacketed with at least a first layer 136. In one or more embodiments, the central strength member 124 further includes a second layer 138. In one or more such embodiments, the first layer 136 is comprised of a first material having a first hardness, and the second layer 138 is comprised of a second material having a second hardness. The first hardness is less than the second hardness. In one or more embodiments, the first material of the first layer 136 comprises a Shore A hardness of 80 or less, in particular in a range from 50 to 80, as measured according to ISO 868. In one or more embodiments, the second material of the second layer 138 comprises a Shore A hardness of greater than 80. In one or more embodiments, the hardness of the second layer 138 is measured in Shore D, according to ISO 868, and the Shore D hardness is in a range from 50 to 60. Advantageously, the central strength member 124 having the two-layer construction renders the central strength member 124 deformable such that the buffer tubes 122 press into the central strength member 124 without being compressed against the central strength member 124.

In one or more embodiments, the first layer 136 and the second layer 138 define a total upjacket thickness around the central member 134. In one or more embodiments, the first layer 136 comprises from 50% to 90% of the total upjacket thickness, in particular about 80% of the total upjacket thickness. In one or more embodiments, the second layer 138 comprises the remainder of the total upjacket thickness. In one or more embodiments, the central strength member 124 has a diameter selected based on the number of buffer tubes 122 stranded around it. In one or more embodiments, the diameter may be, e.g., up to 7 mm, and the central member 134 may have a diameter of 60% to 80% of the diameter of the central strength member 124 with the upjacket of the first layer 136 and the second layer 138 comprising the rest of the diameter. Thus, the total upjacket thickness may be selected to provide the desired diameter of the central strength member 124 for stranding of the buffer tubes 122.

In one or more embodiments, the first material of the first layer 136 comprises a highly-filled polymer, in particular a bedding compound. Such highly-filled polymer materials may include from 60% to 90%, in particular about 80%, of an inorganic filler material and 10% to 40%, in particular about 20%, of a polymer binder. In one or more such embodiments, the inorganic filler material may be a flame retardant compound, such as aluminum trihydrate (ATH) or magnesium dihydroxide (MDH), and the polymer binder may be a thermoplastic elastomer, such as a thermoplastic polyolefin elastomer. Such highly-filled polymer materials have very limited mechanical properties such as tensile strength or elongation at break. Further, such highly-filled polymer material have low hardness, allowing for the buffer tubes 122 to press into the central strength member 124 in response to crush forces.

In one or more embodiments, second material of the second layer 138 is a comparatively harder material such as a polyolefin polymer. In one or more embodiments, the second material is polyethylene (low density, medium density, high density, linear low density, or very low density), polypropylene, polyvinyl chloride, or flame-retardant non-corrosive (FRNC) polymers, amongst other possibilities. The second layer 138 is a skin layer around the first layer 136 that maintains the integrity of the combined upjacket of the central strength member 124. That is, the limited mechanical properties of the first material of the first layer 136 may make it susceptible to crumbling and falling off of the central member 134 during manufacturing. By providing the second layer 138 around the first layer 136, the processability of the central strength member 124 is improved.

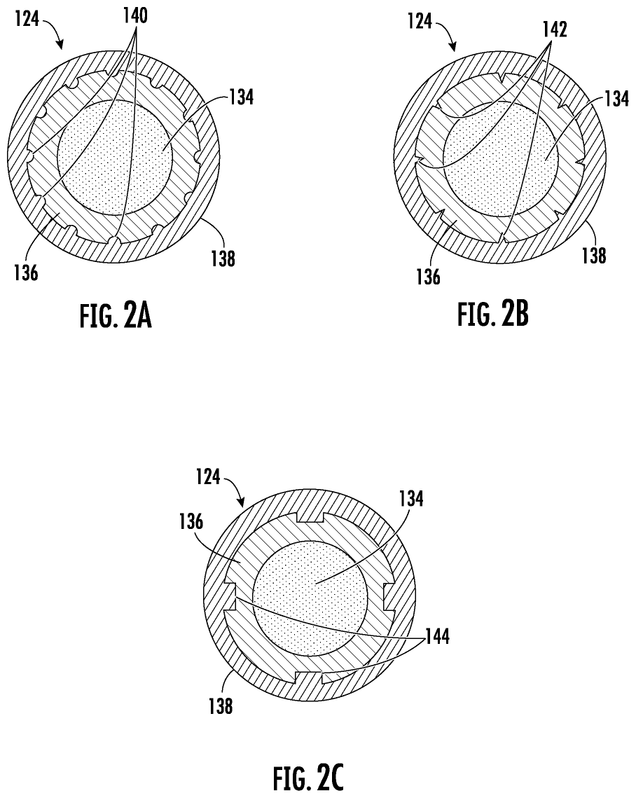

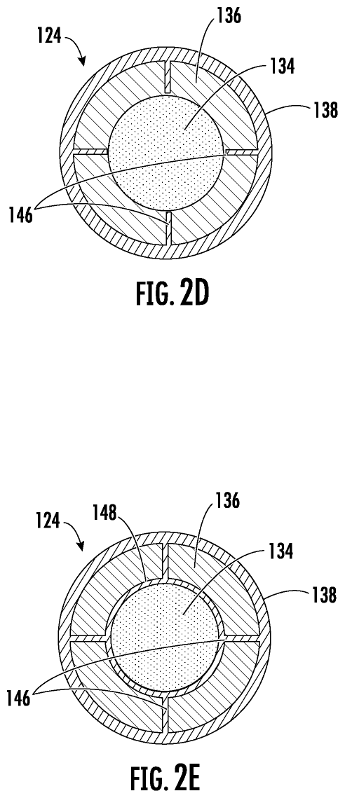

FIGS. 2A-2E depict different embodiments of the central strength member 124. In the embodiment shown in FIG. 1, the first layer 136 and the second layer 138 have substantially constant thicknesses around their circumferences. In the embodiments of FIGS. 2A-2E, the second layer 138 includes features that extend into the first layer 136. For example, as shown in FIG. 2A, the second layer 138 includes a plurality of lobes 140 that extend inwardly into the first layer 136. In FIG. 2B, the second layer 138 includes a plurality of spikes 142 that extend inwardly into the first layer 136. In FIG. 2C, the second layer 138 includes a plurality of bosses 144 that extend inwardly into the first layer 136. Such inwardly extending features as shown in FIGS. 2A-2C may provide various different advantages. For example, the inwardly extending features can be designed to distribute the crush forces differently around the central strength member 124, allowing control of how the crush forces will impact deformation. Additionally, the inwardly extending features can help prevent the central strength member 124 from deforming during cable manufacturing (e.g., during extrusion of the central strength member 124 and during stranding of the buffer tubes 122). Still further, the inwardly extending features may enhance binding between the first layer 136 and the second layer 138 by providing greater surface area of contact between the layers 136, 138. The inwardly extending features may also help control the shape of the central strength member 124 at high temperatures and during application of certain crush forces, and the inwardly extending features may control how the central strength member 124 burns or deforms during burning. Another advantage of the inwardly extending features is to decrease the weight of the cable by replacing a portion of the material of the first layer 136 (which generally has a higher density) with additional material of the second layer 138 (which generally has a lower density). In one or more embodiments, the inwardly extending features, lobes 140, spikes 142, or bosses 144, extend to a depth of up to 50% of the first layer 136, for example.

FIG. 2D depicts an embodiment of the second layer 138 in which a plurality of webs 146 extend through the thickness of the first layer 136. As shown in FIG. 2D, there are four webs 146 separated by about 90° around the inner circumference of the first layer 136. In one or more embodiments, the webs 146 have a thickness that is approximately the same as the thickness of the second layer 138 or less. The webs 146 may provide some or all of the advantages described above with respect to the inwardly extending features, and in addition, the webs 146 may help to keep the central member 134 of the central strength member 124 centered within the optical fiber cable, i.e., to prevent the central member 134 from shifting in the bedding compound of the first layer 136, e.g., during bending.

FIG. 2E depicts an embodiment of the central strength member 124 including a third layer 148. The third layer 148 is formed directly around the central member 134, and the first layer 136 is formed around the third layer 148. In one or more embodiments, the third layer 148 is formed of the same material as the second layer 138. As can be seen in FIG. 2E, the second layer 138 includes a plurality of webs 146 that extend through the thickness of the first layer 136 and connect the second layer 138 to the third layer 148. The structure of the layers 136, 138, 148 and webs 146 may provide some or all of the advantages described above with respect to the inwardly extending features of FIGS. 2A-2C and the webs 146 of FIG. 2D.

In the foregoing two-layer upjacket embodiments, the second layer 138 provides a skin layer that, at least in part, prevents the first layer 136, which may be a highly-filled bedding compound, from falling off of the central member 134. In one or more other embodiments, especially embodiments in which the concern of the first layer 136 falling off of the central member 134 is reduced or nonexistent, the central strength member 124 may only include the first layer 136. In one or more such embodiments, the material of the first layer 136 is a compliant material, such as an FRNC polymer, a polymer foam, or an olefin block copolymer (such as INFUSE™ 9107 available from The Dow Chemical Company, Midland, MI). In one or more embodiments, the compliant material of the first layer 136 comprises a Young's modulus of 120 MPa or less, in particular 100 MPa or less, and more particularly 50 MPa or less. In one or more embodiments, the FRNC polymer is similar to the bedding compound in that it contains a polymer component (such as polyamide and/or polyester) and a flame retardant filler component (such as ATH and/or MDH), but an FRNC polymer contains less of the flame retardant filler component (e.g., less than 60 wt %) than a bedding compound. Thus, the mechanical properties of an FRNC polymer are much better than a bedding compound, limiting the risk of the FRNC crumbling off of the central member 134. Similarly, the polymer foam and olefin block copolymer have good mechanical properties and coating capabilities but are more compliant than polymers typically used as an upjacket for the central member 124, such as LLDPE. Because the first layer 136 of such materials is compliant to cushion the buffer tubes 122 under crush forces and because the first layer 136 is not prone to crumbling off of the central member 134, the second layer 138 is not needed according to this embodiment.

As with the two-layer central strength member 124 embodiment, the diameter of the single layer central strength member 124 may be, e.g., up to 7 mm, and the central member 134 may have a diameter of 60% to 80% of the diameter of the central strength member 124 with the upjacket of the first layer 136 comprising the rest of the diameter.

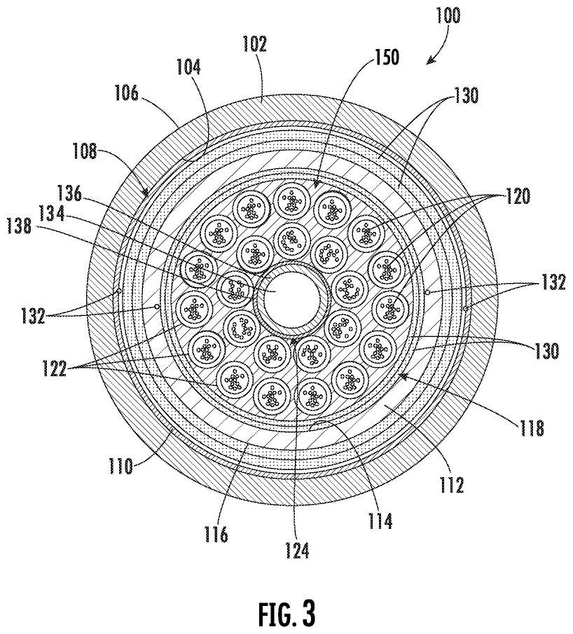

FIG. 3 depicts another example embodiment of an optical fiber cable 100 configured to provide enhanced crush resistance. As can be seen in FIG. 3, the optical fiber cable 100 includes the first material as a filling compound 150 between the buffer tubes 122 in the cable core inside of the inner jacket 112. In one or more embodiments, the filling compound 150 is disposed between the central strength member 124 and the first layer of buffer tubes 122. In one or more embodiments, the filling compound 150 is alternatively or additionally disposed between the first layer of buffer tubes 122 and the second layer of buffer tubes 122. In one or more embodiments, the filling compound 150 is alternatively or additionally disposed between the second layer of buffer tubes 122 and the inner jacket 112. Thus, the filling compound 150 may provide deformable material to accommodate crush forces between the inner jacket 112 and the outer layer of buffer tubes 122, between and among the buffer tubes 122, and between the inner layer of buffer tubes 122 and the central strength member 134. In one or more embodiments, the filling compound 150 is the same material as the first material as described above, such as a bedding compound.

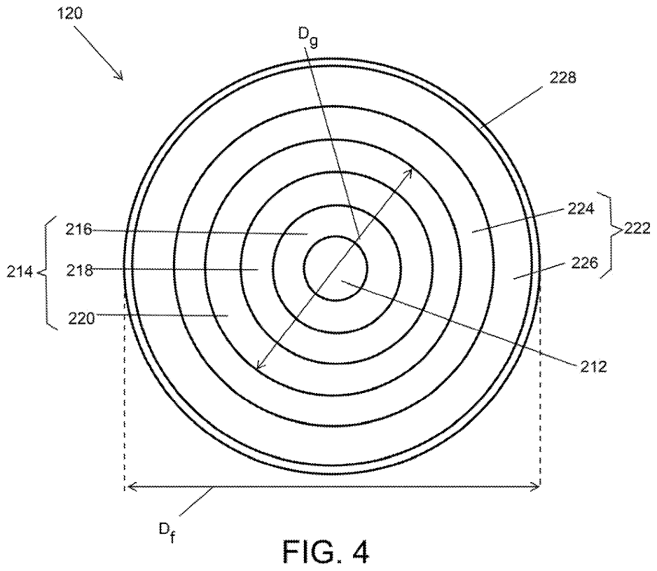

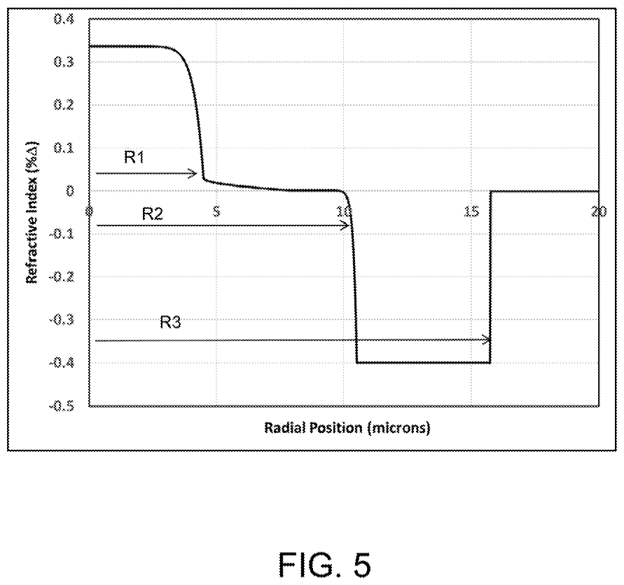

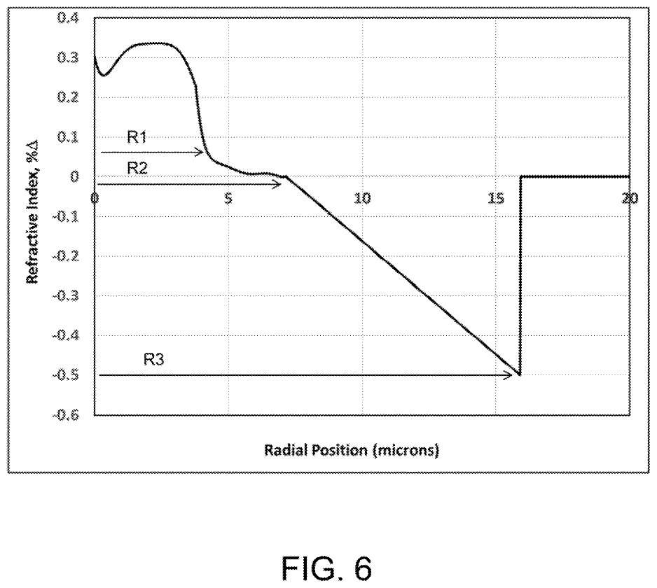

In one or more of any of the foregoing embodiments, the crush resistance of the optical fiber cable 100 can be further improved by utilizing a low-bend loss optical fiber 120. Referring to FIG. 4, a terminal end or cross-sectional view of such an optical fiber 120 is depicted. The optical fiber 120 includes a core 212 surrounded by a cladding region 214. In one or more embodiments, including the embodiment depicted in FIG. 4, the cladding region 214 includes a first cladding layer 216, a second cladding layer 218, and a third cladding layer 220. However, in one or more other embodiments, the cladding region 214 only includes two layers of cladding. In embodiments, the second cladding layer 218 of the three layer cladding region 214 defines a trench region as will be discussed more fully below. In embodiments in which the cladding region 214 only has two layers, the cladding layer adjacent to the core 212 defines the trench region. Further, as will be discussed more fully below, the trench region may have a substantially constant refractive index (referred to as a “rectangular trench”) as shown in FIG. 5, or the trench region may have a continuously varying refractive index (“referred to as a triangular trench”) as shown in FIG. 6.

In some embodiments, the outer trench radius (corresponding to R₃ in the embodiment of FIGS. 5 and 6) is between 11 microns and 20 microns. In other embodiments, the outer trench radius is between 12 microns and 18 microns.

In one or more embodiments, the core 212 and cladding region 214 are comprised of a glass material. In one or more embodiments, the core is comprised of germania-doped silica, and the trench (e.g., second cladding layer 218 in the embodiment of FIG. 4) is comprised of a fluorine-doped silica. In one or more embodiments, the shape of the optical fiber 120 may be a circular end shape or circular cross-sectional shape as shown in FIG. 4. In one or more other embodiments, end and cross-sectional shapes and sizes may be employed including elliptical, hexagonal and various polygonal forms.

In one or more embodiments, the core 212 has a first radius R₁ that is from 4 microns to 6 microns. In one or more embodiments, the first cladding layer 216 has a second radius R₂, the second cladding layer 218 has a radius R₃, and the third cladding layer 220 has a radius R₄. In one or more embodiments, the second radius R₂ is from 7 microns and 13 microns. In one or more embodiments, the third radius R₃ is from 11 microns and 20 microns. In one or more embodiments, the fourth radius R₄ is from 60 microns to 65 microns. The cladding region 214 defines a maximum cross-sectional dimension of the glass of the optical fiber 120. In embodiments in which the optical fiber 120 has a circular end or cross-section, the maximum cross-sectional dimension is a glass diameter D_{g} of the optical fiber 120. In one or more embodiments, the glass diameter D_{g} is from 120 microns to 130 microns.

The core 212 and the cladding region 214 define a refractive index profile of the optical fiber 120, examples of which are shown in FIGS. 5 and 6. The refractive index profile is the relationship between refractive index or relative refractive index and waveguide (core and cladding) fiber radius. The radius for each region of the refractive index profile is given by the abbreviations r₁, r₂, r₃, r₄, etc. and lower and upper case are used interchangeably herein (e.g., r₁ is equivalent to R₁). For the purpose of this disclosure, the refractive index in each of the core 212, first cladding layer 216, and second cladding layer 218 are defined with respect to the refractive index Δ₄ of the third cladding layer 220. Further, the refractive index referenced herein is the refractive index measured at a wavelength of 1550 nm. This is referred to as the “relative refractive index percent” and is defined as Δ%=100×(nᵢ²−n_{c}²)/2nᵢ², and as used herein nᵢ is the refractive index of referenced region i of the optical fiber 120 and n_{c} is the refractive index of undoped silica found in the third cladding layer 220. In cases where the refractive index of a region is less than the average refractive index of the third cladding layer 220, the relative refractive index percent is negative and is referred to as having a depressed region or depressed index. In cases where the refractive index of a region is greater than the average refractive index of the third cladding layer 220, the relative refractive index percent is positive. Because the third cladding layer 220 is the reference refractive index, then Δ₄=0% Δ. As shown in FIGS. 5 and 6, the core 212 has a maximum core index of Δ_{1,max}. In one or more embodiments, the maximum core refractive index Δ_{1,max} is between 0.3% Δ and 0.45% Δ. Further, the first cladding layer 216 has an average index of Δ₂. In one or more embodiments, the refractive index Δ₂ is between −0.05% Δ to 0.05% Δ. The second cladding layer 218 defining the fluorine doped trench has a minimum trench index of Δ_{3,min}. In one or more embodiments, the minimum trench refractive index Δ_{3,min} is between −0.1% A and −0.5% Δ, in particular between −0.15% Δ and −0.4% Δ.

The refractive index of each region (core 212, first cladding layer 216, and second cladding layer 218) may be varied relative to the third cladding layer 220 by utilizing updopants or downdopants. An “updopant” is herein considered to be a dopant which has a propensity to raise the refractive index relative to pure undoped SiO₂. Examples of updopants include GeO₂ (germania), Al₂O₃, P₂O₅, TiO₂, Cl, Br. A “downdopant” is herein considered to be a dopant which has a propensity to lower the refractive index relative to pure undoped SiO₂. Examples of down dopants include fluorine and boron.

As mentioned, the cladding region 214 may include a cladding layer with a depressed refractive index referred to as a trench. The size of the trench may be described in terms of its volume. As used herein, the trench volume V is given by the following equation:

$$V = \vert 2 {\int }_{{r}_{Trench , inner}}^{{r}_{Trench , outer}} ( {Δ}_{Trench} ( r ) - {Δ}_{c} ) rdr \vert$$

where r_{Trench,inner} is the inner radius of the trench cladding region, r_{Trench,outer} is the outer radius of the trench cladding region, Δ_{Trench}(r) is the relative refractive index of the trench cladding region, and Δ_{c} is the average relative refractive index of the common outer cladding region of the glass fiber. In the embodiments depicted in FIGS. 5 and 6 in which the trench is the second cladding layer 218, r_{Trench,inner} is r₂, r_{Trench,outer} is r₃, Δ_{Trench} is Δ₃(r), and Δ_{c} is Δ₄. Further, as shown in the equation above, trench volume is defined as an absolute value and has a positive value. Trench volume is expressed herein in units of % Δ-μm².

In one or more embodiments, the cladding region 214 includes a cladding layer (e.g., second cladding layer 218) having a trench volume of greater than about greater than about 25% Δ-μm². In one or more embodiments, the trench volume is greater than about 30% Δ-μm², greater than about 40% Δ-μm², greater than about 50% Δ-μm², or greater than about 60% % Δ-μm². In one or more embodiments, the trench volume is less than about 70% Δ-μm², less than about 65% Δ-μm², or less than about 60% Δ-μm². In one or more embodiments, the trench volume is from about 25% Δ-μm² to about 70% Δ-μm², about 30% Δ-μm² to about 70% Δ-μm², about 40% Δ-μm² to about 70% Δ-μm², about 50% Δ-μm² to about 70% Δ-μm², about 60% Δ-μm² to about 70% Δ-μm², about 30% Δ-μm² to about 60% Δ-μm², about 30% Δ-μm² to about 50% Δ-μm², about 30% Δ-μm² to about 40% Δ-μm², about 40% Δ-μm² to about 60% Δ-μm², or about 50% Δ-μm² to about 60% Δ-μm². For example, the trench volume is about 30% Δ-μm², about 35% Δ-μm², about 40% Δ-μm², about 45% Δ-μm², about 46% % Δ-μm², about 47% Δ-μm², about 48% % Δ-μm², about 49% Δ-μm², about 50% Δ-μm², about 55% Δ-μm², about 60% Δ-μm², about 61% Δ-μm², about 62% Δ-μm², about 68% Δ-μm², about 69% Δ-μm², about 70% Δ-μm², or any trench volume between these values.

In one or more embodiments, the core 212 comprises a step index with a core alpha of greater than 10. In one or more other embodiments, the core 212 is a graded index core having a core alpha in a range from 1.5 to 5. The core alpha is defined as an exponent a in which the refractive index in the core 212 as a function of radial position is described by the refractive index relation Δ% (r)=Δ_{1,max}*[1−(r/R₁)^{α}].

With reference again to FIG. 4, a coating 222 is disposed around the cladding region 214, and the coating 222 surrounds and encapsulates the glass core 212 and cladding region 214. In embodiments, the coating 222 is configured to provide mechanical protection for the optical fiber 120. In one or more embodiments, the coating 222 includes an inner or primary coating 224 and an outer or secondary coating 226. In one or more embodiments, the primary coating 224 directly contacts the cladding region 214, and the secondary coating 226 directly contacts the primary coating 224. In one or more embodiments, the secondary coating 224 defines the outermost surface of the optical fiber 120. However, in one or more other embodiments, the optical fiber 120 further includes a color layer 228, which may be used to identify the optical fiber 120. In embodiments in which the color layer 228 is included, the color layer 228 may define the outermost surface of the optical fiber 120.

In one or more embodiments, the coating 222 has a thickness in a range from 22 microns to 45 microns, in particular in a range from 22 microns to 40 microns, and more particularly in a range from 22 microns to 35 microns. In one or more embodiments, the coating 222 has a ratio of the thickness of the secondary coating 226 to the thickness of the primary coating 224 in the range of 0.65 to 1.0. According to one or more other embodiments, the ratio of the secondary coating 226 thickness to the primary coating 224 thickness may be in the range of 0.70 to 0.95, more particularly in the range of 0.75 to 0.90, and most particularly in the range of 0.75 to 0.85. In one or more embodiments, the primary coating 224 may have a thickness in the range from 12 microns to 25 microns, in particular in a range from 12 microns to 22 microns, and more particularly in a range from 12 microns to 19 microns. In one or more embodiments, the secondary coating 26 may have a thickness in a range from 10 microns to 20 microns, in particular in a range from 10 microns to 18 microns, and more particularly in a range from 10 microns to 16 microns. In one or more embodiments, the color layer 28 may have a thickness equal to or less than 10 microns, in particular equal to or less than 8 microns, and more particularly in the range of 2 microns to 8 microns.

In one or more embodiments, the optical fiber 120 has an overall fiber diameter D_{f} equal to or less than 200 microns. More specifically, in one or more embodiments, the overall fiber diameter D_{f} may be in the range from 160 microns to 200 microns, in a range from 160 microns to 190 microns, in a range from 160 microns to 180 microns, in a range from 160 microns to 170 microns, in a range from 170 microns to 200 microns, in a range from 170 microns to 190 microns, in a range from 170 microns to 180 microns, in a range from 180 microns to 200 microns, or in a range from 180 microns to 190 microns.

In one or more embodiments, the primary coating layer 222 has a Young's modulus (also referred to herein as “elastic modulus”) of less than 1 MPa and a T_{g} (glass transition temperature) of less than −20° C., and the secondary coating layer 224 has a Young's modulus of greater than 1500 MPa and a T_{g} of greater than 65° C.

By using a low-bend loss optical fibers 120 as described above, the crush resistance of the optical fiber cable 100 can be further improved because the optical fibers 120 themselves are more resistant to attenuation changes resulting from pressures exerted on the optical fibers 120 by the cable jackets 102, 112. Thus, any crush forces transmitted through jackets 102, 112 are better accommodated by the low-bend loss optical fibers 120. An example of a commercially available low-bend loss optical fiber 120 is SMF-28® Contour optical fibers available from Corning Incorporated, Corning, NY.

### EXPERIMENTAL EXAMPLE

An optical fiber cable 100 was constructed according to the present disclosure. The optical fiber cable 100 included optical fibers 120 having diameters of 0.250 mm in buffer tubes 122 having an outer diameter of 2.25 mm and an inner diameter of 1.70 mm. The buffer tubes 122 were PC-PBT composites. There were 9 buffer tubes in an inner layer stranded around the central strength member 124 with an outer diameter of 4.6 mm, providing diameter of the first buffer tube layer of about 9.4 mm. A second layer of 15 buffer tubes 122 was stranded around the first layer of buffer tubes 122. The second layer of buffer tubes 122 defined a diameter of about 14.2 mm. The second layer of buffer tubes 122 were wrapped with three layers of strengthening yarns 130, including one layer of aramid yarns (9480 dtex) and two layers of glass yarns (1200 dtex). The layers of strengthening yarns 130 defined a diameter of about 15.0 mm. Surrounding the strengthening yarns 130 was an inner jacket 112 of HDPE having a jacket thickness of about 3.0 mm. The outer diameter of the inner jacket 112 was 21.0 mm. The inner jacket 112 was surrounded by three layers of strengthening yarns 130 (glass yarns of 1200 dtex). The strengthening yarns 130 defined a diameter of 22.2 mm. An armor layer 110 of steel tape was wrapped around the strengthening yarns 130, defining an outer diameter of 23.3 mm. Finally, the armor layer 110 was surrounded by an outer jacket 102 of HDPE having a jacket thickness of 2.0 mm to provide a total cable diameter of 27.3 mm.

The central strength member 124 included a GRP rod as the central member 134 having a diameter of 3.4 mm. A first layer 136 of bedding compound having a thickness of 0.5 mm was provided around the central member 134. The bedding compound was FM0474/5 (available from Melos GmbH, Melle, Germany). The bedding compound had a Shore A hardness of 74. The second layer 138 was LLDPE having a thickness of 0.1 mm. Thus, the total upjacket thickness was 0.6 mm to define the diameter of the central strength member 124 of 4.6 mm.

A comparative cable having the same construction was prepared but the central strength member included a GRP central member surrounded by an upjacket of LLDPE having a thickness of 0.6 mm, which provided a central strength member having a total diameter of 4.6 mm.

The optical fiber cable 100 according to the present disclosure and the comparative cable were subjected to crush testing in which each cable was positioned between 10 cm×10 cm square metal plates. The cables were loaded with 10 kN of force according to IEC 607941-21, Method E3, and the attenuation in the optical fibers was measured.

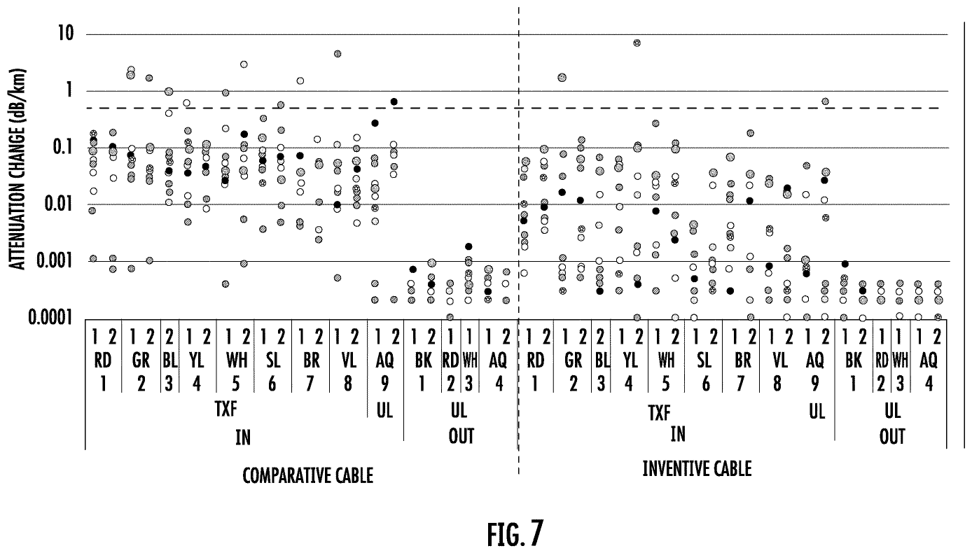

FIG. 7 provides a graph of the attenuation change measured in the optical fibers of each cable. The comparative cable is shown on the left side of the graph, and the optical fiber cable 100 according to the present disclosure is shown on the right side of the graph. As can be seen, several of the optical fibers (about 4% of the optical fibers) in the comparative cable experienced attenuation change of greater than 0.5 dB during crush testing. In contrast, only three optical fibers (about 1% of the optical fibers) of the optical fiber cable 100 according to the present disclosure experienced an attenuation change of greater than 0.5 dB. Further, the level of attenuation change overall was lower for the optical fiber cable 100 than for the comparative cable. Based on the attenuation change measured during crush testing, Applicant believes that the disclosed construction of the central strength member 124 allowed for the central strength member 124 to deform when the buffer tubes 122 were pressed into the central strength member 124 during crush testing. In contrast, the buffer tubes of the comparative cable were compressed against the rigid central strength member, leading to higher attenuation change.

### SIMULATED EXAMPLE

An optical fiber cable 100 according to the present disclosure was modeled using finite element analysis (FEA). The optical fiber cable 100 included the elements and had the dimensions, except as noted, provided in the previous example. The inner jacket 112 was varied in thickness between 1.5 mm and 3.0 mm. Further, the central strength member 124 was modeled with a single layer, in particular first layer 136, of two different materials surrounding the GRP central member 134. In one of the modeled optical fiber cables 100, the first layer 136 was comprised of LLDPE having a thickness of 0.6 mm, and in another of the modeled optical fiber cables 100, the first layer was comprised of an FRNC polymer, also having a thickness of 0.6 mm. In the modeled optical fiber cables 100, the first layer of buffer tubes 122 was wound around the central strength member 124 at a pitch 100 mm, and the second layer of buffer tubes 122 was wound around the first layer at a pitch of 130 mm. The second layer of buffer tubes 122 was wound in an opposite direction than the first layer of buffer tubes 122.

Using FEA, the effect of changing the thickness of the inner jacket 112 and of changing the material of the first layer 136 of the central strength member 124 was studied. Through previous experience, Applicant has found that the deformation mode of buffer tubes 122 for a single jacket cable are substantially the same as for a dual jacket cable when exposed to a slightly lower crush load. Therefore, the analysis considered a crush load of 7 kN/100 mm applied to the inner jacket 112 over a 10 mm long portion of the optical fiber cable 100 without the outer jacket 102, armor layer 110, and intervening strengthening yarns 130.

To perform the analysis, properties were ascribed to each component of the optical fiber cable 100. The strengthening yarns 130 (glass and aramid yarns) were modeled as incompressible materials. The material properties for the materials of the remaining layers involved in the FEA are provided in the Table below.

TABLE
Material Properties Used in FEA Simulation

| | | Young's modulus | Poisson's | Yield strain |
|---|---|---|---|---|
| Material | Material model | (MPa) | ratio | (%) |
| HDPE | Elastic-plastic | 262 | 0.45 | 6.3 |
| PC | Elastic-plastic | 2300 | 0.36 | 1.0 |
| PBT | Elastic-plastic | 2600 | 0.33 | 1.0 |
| GRP | Linearly elastic | 10000 | 0.3 | N/A |
| LLDPE | Elastic-plastic | 129 | 0.44 | 6.3 |
| FRNC | Elastic-plastic | 110 | 0.44 | 5.9 |

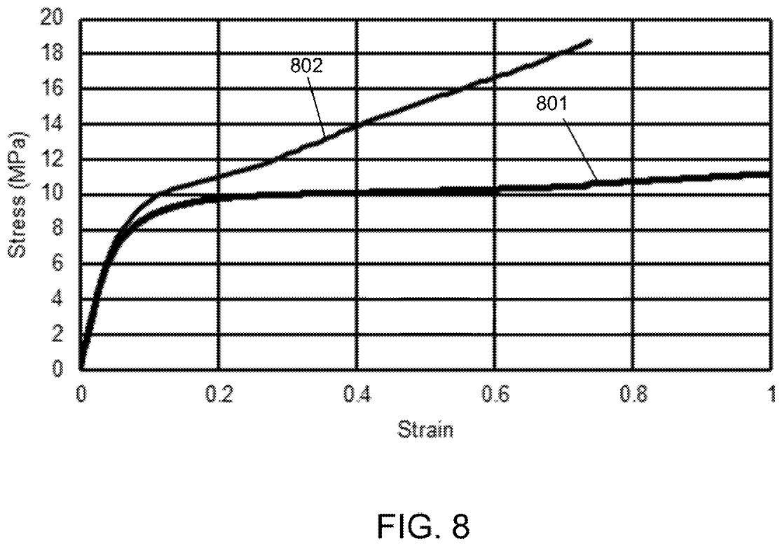

Further, FIG. 8 provides a comparison of the stress-strain relation for the materials used in the simulation for the first layer 136 of the central strength member 124. As can be seen in FIG. 8, the first stress-strain curve 801 for FRNC demonstrates a lower Young's modulus and has a less pronounced hardening effect, thus exhibiting a more compliant mechanical behavior than the second stress-strain curve 802 for LLDPE.

Four cables were modeled: (1) 1.5 mm HDPE inner jacket 112 and LLDPE first layer 136; (2) 3.0 mm HDPE inner jacket 112 and LLDPE first layer 136; (3) 1.5 mm HDPE inner jacket 112 and FRNC first layer 136; and (4) 3.0 mm HDPE inner jacket 112 and FRNC first layer 136. From the FEA simulation in each of the simulations, it was observed that the inner layer of buffer tubes 122 were more prone to largest deformation under the critical crush load of 7 kN/100 mm. Further, the buffer tubes 122 of the inner layer closest to the loading plate (that downwardly applies the crush load) exhibited the most severe shape change and cross-sectional area shrinkage. The buffer tubes 122 of the inner layer and the outer layer closest to the bottom rigid plate also exhibited deformation that was larger than average. Additionally, based on how the tubes moved in response to the crush load, buffer tubes on the mid-line exhibited some larger than average deformation as a result of being squeezed between other buffer tubes.

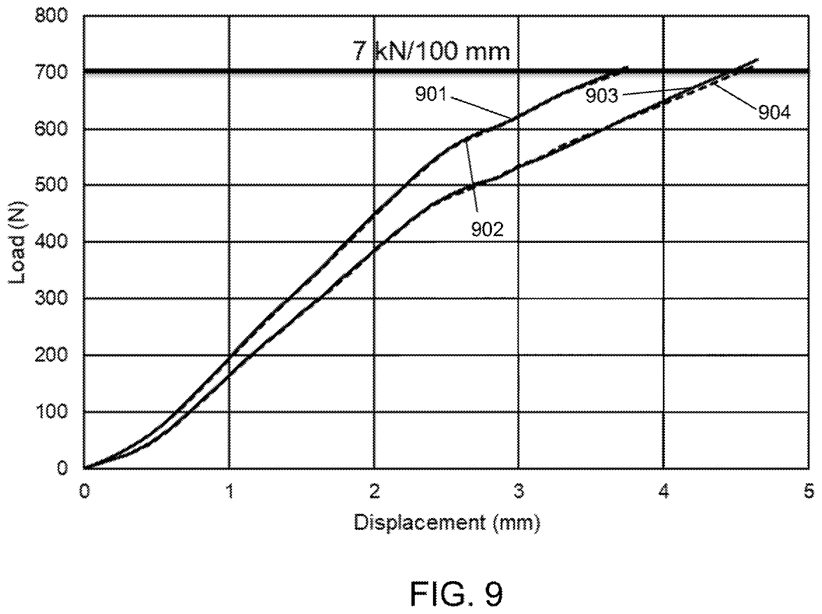

Further, the FEA simulations of the four cables demonstrated that the thicker jacket provided a stiffer macroscopic anti-crush response with steeper load-displacement curves (curves 901, 902) as shown in FIG. 9. On the other hand, the optical fiber cables 100 utilizing the FRNC first layer 136 required higher displacement (curves 902, 904) to reach critical load. In particular, using FRNC as the material of the first layer 136 (curves 902, 904) instead of LLDPE (901, 903) increased the displacement required to reach the critical load by 1.7% for the 1.5 mm inner jacket 112 and by 1.1% for the 3.0 mm inner jacket 112.

Based on the FEA simulations, using a thicker inner jacket 112 may reduce cross-sectional area deformation during crush loading by 6% for an LLDPE first layer 136 and by 8% for an FRNC first layer 136. Further, using a more compliant first layer 136, such as FRNC instead of LLDPE, may require the buffer tubes 122 to under more displacement before reaching the critical crushing load. Further, using a more compliant first layer 136 may lead to less cross-sectional area deformation by up to 8% when used in conjunction with the 1.5 mm thick inner jacket 122 and by up to 11% less when used in conjunction with the 3.0 mm inner jacket 122.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
an outer jacket comprising a first inner surface and a first outer surface, the first outer surface defining an outermost surface of the optical fiber cable and the first inner surface defining a first central bore extending along a longitudinal axis of the optical fiber cable;
an inner jacket disposed within the first central bore, the inner jacket comprising a second inner surface and a second outer surface, the second inner surface defining a second central bore extending along the longitudinal axis;
an armor layer disposed in the first central bore between the first inner surface of the outer jacket and the second outer surface of the inner jacket;
a central strength member disposed within the second central bore, the central strength member comprising a central member, a first layer disposed around the central member, and a second layer disposed around the first layer; and
a plurality of buffer tubes disposed within the second central bore and around the central strength member, each buffer tube of the plurality of buffer tubes containing at least one optical fiber;
wherein the first layer comprises a first material having a first hardness, the second layer comprises a second material having a second hardness, the first hardness being less than the second hardness.

2. The optical fiber cable of claim 1, wherein the first material of the first layer comprises a highly-filled polymer comprising from 60 wt % to 90 wt % of an inorganic filler and 10 wt % to 40 wt % of a polymer binder.

3. The optical fiber cable of claim 2, wherein the second material of the second layer comprises a polyolefin polymer.

4. The optical fiber cable of claim 1, wherein the first hardness is a Shore A hardness in a range from 50 to 80.

5. The optical fiber cable of claim 1, wherein the first layer and the second layer comprise a total thickness and a thickness of the first layer is in a range of 50% to 90% of the total thickness.

6. The optical fiber cable of claim 1, wherein the central member comprises a fiber-reinforced plastic rod or a metal wire.

7. The optical fiber cable of claim 1, wherein, during application of a compressive force of 10 kN to the first outer surface of the outer jacket that is perpendicular to the longitudinal axis, a change in attenuation to optical signals carried by the at least one optical fiber of each buffer tube of the plurality of buffer tubes is 0.5 dB or less.

8. The optical fiber cable of claim 7, wherein, after the compressive force is removed, the change in attenuation to the optical signals carried by the at least one optical fiber of each buffer tube of the plurality of buffer tubes is less than 0.05 dB.

9. The optical fiber cable of claim 1, wherein the second layer comprises a plurality of features that extend into the first layer.

10. The optical fiber cable of claim 9, wherein the plurality of features comprise lobes, spikes, or bosses.

11. The optical fiber cable of claim 9, wherein the plurality of features extend up to 50% through a thickness of the first layer.

12. The optical fiber cable of claim 1, wherein the second layer comprises a plurality of webs that extend through a thickness of the first layer.

13. The optical fiber cable of claim 12, wherein the central strength member comprises a third layer disposed between the first layer and the central member and wherein the plurality of webs extend from the second layer to the third layer.

14. The optical fiber cable of claim 1, wherein the plurality of buffer tubes comprises a first layer of buffer tubes and a second layer of buffer tubes, the second layer of buffer tubes comprising more buffer tubes than the first layer of buffer tubes and the second layer of buffer tubes surrounding the first layer of buffer tubes.

15. The optical fiber cable of claim 14, further comprising a plurality of strengthening yarns stranded around the second layer of buffer tubes.

16. An optical fiber cable, comprising:
an outer jacket comprising a first inner surface and a first outer surface, the first outer surface defining an outermost surface of the optical fiber cable and the first inner surface defining a central bore extending along a longitudinal axis of the optical fiber cable;
a central strength member disposed within the central bore, the central strength member comprising a central member and a first layer disposed around the central member; and
a plurality of optical fibers disposed within the central bore, the plurality of optical fibers being divided among a plurality of buffer tubes positioned around the central strength member;
wherein the first layer comprises a first material having a Young's modulus of 120 MPa or less; and
wherein, during application of a compressive force of 10 kN to the first outer surface of the outer jacket that is perpendicular to longitudinal axis, 1% or less of the plurality of optical fibers experience a change of attenuation of 0.5 dB or more.

17. The optical fiber cable of claim 16, wherein the first material of the first layer comprises a flame retardant, non-corrosive polymer; a polymer foam; or an olefin block copolymer.

18. The optical fiber cable of claim 16, further comprising an inner jacket disposed within the central bore and surrounding the central strength member, the plurality of optical fibers, and the plurality of buffer tubes, wherein the inner jacket comprises a thickness in a range from 1.5 mm to 3 mm.

19. The optical fiber cable of claim 16, wherein the plurality of optical fibers comprise low bend loss optical fibers having a core and a cladding region surrounding the core, the cladding region comprising a trench with a depressed refractive index.

20. The optical fiber cable of claim 16, wherein the plurality of buffer tubes comprises a first layer of buffer tubes and a second layer of buffer tubes, the first layer of buffer tubes being wound around the central strength member and the second layer of buffer tubes being wound around the first layer of buffer tubes.
